(19) United States
(12) Patent Application Publication
(10) Pub. No.: US 2004/0071865 A1
(43) Pub. Date: Apr. 15, 2004

(54) Method for making an assembly of base elements for a fuel cell substrate

(76) Inventors: Renaut Mosdale, Claix (FR); Pierre Baurens, Coublevie (FR)

Correspondence Address: Pearne Gordon, McCoy & Grange, Suite 1200, 526 Superior Avenue, Cleveland, OH, 44114-1484, US

(21) Appl. No.: 10/451,169

(22) PCT Filed: Dec. 28, 2001
(86) PCT No.: PCT/FR01/04221

(30) Foreign Application Priority Data
Dec. 29, 2000 (FR) 00/17279

(51) Int. Cl. B05D 5/12; H01M 8/10

(52) U.S. Cl. 427/115; 429/32

(57) ABSTRACT

The method enables manufacture of assemblies of several basic elements for a stage of a fuel cell, without making use of expensive machining or difficult mechanical assemblies.

The method consists of using a basic porous matrix (20) in which an ionic conductor (24) surrounded by an anode (22) and an electrode (23) is deposited, for each basic element, and the assembly is isolated by a peripheral seal (21) and pairs of isolating walls (25). Electronic conductors (26) connect the anode (22) of a basic element to the cathode (23) of the basic element adjacent to it.

This method may be applied to all fuel cells.

### DOMAIN OF THE INVENTION

This invention relates to all energy production installations using fuel cells. It is equally applicable to local or centralized production, and to land, space or sea transport. The power range of this type of fuel cell is very broad, since it includes mobile or portable equipment generating a few milliwatts and static installations generating a power of several kilowatts.

### PRIOR ART AND PROBLEM THAT ARISES

Fuel cells are electrochemical cells composed of a stack of stages that generate electricity. Each stage comprises an anode and a cathode placed on each side of an electrolytic element. A different reagent arrives on each outside surface of the two electrodes, namely a fuel on one side and an oxidant on the other side. The fuel and the oxidant react chemically through the electrolytic element such that an electric voltage of the order of 1 volt at zero current can be measured at the terminals of the two electrodes. If the fuel is hydrogen and the oxidant is oxygen, oxidation of hydrogen takes place at the anode while the oxygen is reduced to water at the cathode. The low voltage produced is the most serious disadvantage of the fuel cell system compared with conventional batteries in which the elementary voltage may be as high as 4 volts. To overcome this problem, the normal practice is to build up fuel cells made of a stack of a large number of basic elements or electricity generating stages using a technology that can be called “press-filter”.

With reference to FIG. 1, this type of fuel cell is composed of a stack of a large number of stages. Each stage is composed of a basic element composed of a membrane/electrodes assembly 2 comprising a membrane and two electrodes and two halves of two 2-pole plates 3 each placed between two membrane/electrodes basic elements 2 of two consecutive stages. At least one header pipe 4A supplies each stage with hydrogen and at least one header pipe 4B supplies each stage with oxygen. Header pipes to remove products derived from the oxidation-reduction reaction are also provided at the periphery of this stack, but are not shown in FIG. 1. The entire stack is clamped between two end plates 1.

One particular technical problem among the various problems that arise relating to this type of technology, is an uncertain distribution of oxygen and hydrogen in each circulation cell in each stage. Problems also arise with leak tightness in the stack and these problems become worse as the number of stages increases. Furthermore, 2-pole plates 3 each separating two membrane/electrodes basic elements 2, must be able to satisfy specific physical and chemical criteria such as very good electronic conductivity, impermeability to gases forming the oxidant and the fuel, a low mass, chemical resistance to water, oxygen and hydrogen when oxygen and hydrogen are the oxidant and the fuel, low cost of the material used and good machineability.

As a result, two-pole plates are used at the moment which are expensive partly because of the large amount of machining and the use of expensive materials. Furthermore, the parallelepiped shape usually used in such stacks is not very suitable for integration of this equipment.

With reference to FIG. 2, U.S. Pat. No. 5,863,672 describes a fuel cell using a particular type of membrane/electrodes basic element. It is composed of an assembly of several membrane/electrodes basic elements, in other words several individual cells 10 placed side by side or one behind the other, an anode 11 and a cathode 12 clamping an electrolytic layer 13. These individual cells 11 are separated by isolating areas 17, but are connected to each other through a conducting part 14. A first end 15 of this conducting part 14 is connected to the cathode 12 of a first cell 10, while a second end 16 of this conducting part 14 is connected to the anode 11 of the cell 10 adjacent to it.

It is easy to imagine the difficulty that arises in making such an assembly of basic elements, not only for making the various individual cells at small scale, but also for making their electrical connections between them. Furthermore, there are still leak tightness problems at the stack forming each of these individual cells. Finally, this type of assembly is relatively thick, which increases the size of the cell formed by a stack of a large number of stages using such an assembly.

Therefore, the main purpose of the invention is to S overcome these disadvantages by proposing a process for making an assembly of membrane/electrodes basic elements for fuel cells, comprising several elementary cells and that can be made in a production series, reliably, without any machining, and that can be used for optimum leak tightness between this type of assembly of membrane/electrodes elements and their two-pole plates.

### SUMMARY OF THE INVENTION

The main purpose of the invention to achieve this objective is a process for making an assembly of anode/membrane/cathode basic elements of a stage of a fuel cell and composed of several anode/membrane/cathode basic elements electrically connected to each other through an electronic conductor connecting the anode of a basic element to the cathode of the adjacent basic element. Therefore, the assembly comprises:

a series of anodes on a first side of a plate forming the assembly, isolated from each other;

a series of cathodes on the second side of the plate forming the assembly, isolated from each other and slightly offset from the series of anodes;

an ionic conductor between each anode/cathode pair placed within the thickness of the assembly;

the electronic conductor of pairs of vertical isolating walls around the ionic conductor; and

a peripheral seal placed around all these elements through the entire thickness of the plate, with a slight overthickness on each side.

According to the invention, the process consists mainly of using a plate of grid material as a support and on which the constituent materials of the different elements of the assembly are deposited, and depositing a joint layer through the entire thickness of the plate and pairs of vertical isolating walls to delimit the different elementary cells or basic elements.

Therefore, in the preferred procedure of the process according to the invention, the first operation is therefore to cut out a piece of the plate of grid material to the required shape.

Preferably, this grid material may be made of a porous matrix made of Teflon or glass.

The third operation is preferably to deposit the ionic conductor inside the plate, but not between the two vertical walls that will delimit the elementary cells.

In this case, the fourth operation is deposition of the electronic conductor between two vertical isolating walls of all pairs.

The next operation is to deposit anodes on a first surface of the plate thus filled in and cathodes on the other surface of this same plate.

An electronic conductor is placed on one of the two ends of the series of anodes and cathodes, opposite each other.

### LIST OF FIGURES

The invention, and its various characteristics and manufacturing phases, will be better understood after reading the following description, illustrated by several figures:

FIG. 1, already described, shows a traditional structure of a fuel cell;

FIG. 2 shows an assembly of basic elements used in a stage of a fuel cell according to a particular type of prior art;

FIG. 3 shows an exploded sectional view of an assembly of basic elements made using the process according to the invention;

FIG. 4 shows an exploded sectional view of a plate of grid material used in the process according to the invention;

FIG. 5 shows an exploded sectional view of the plate in FIG. 4 after the first deposition phase of the seal material;

FIG. 6 shows an exploded sectional view of the same plate as FIG. 5, after the ionic conductor deposition phase,

FIG. 7 shows an exploded sectional view of the same plate as FIG. 6, after the electronic conductor deposition phase; and

FIG. 8 shows a sectional view of the structure of a fuel cell using assemblies derived from a manufacturing process according to the invention.

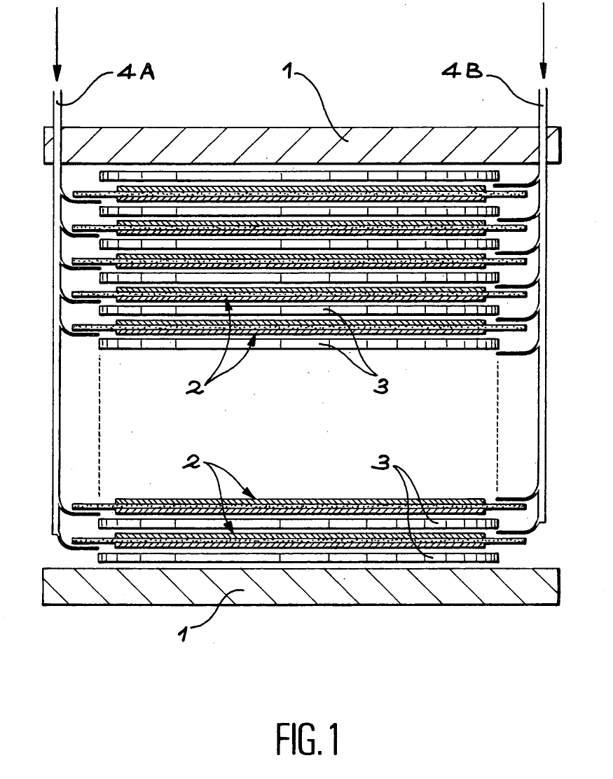

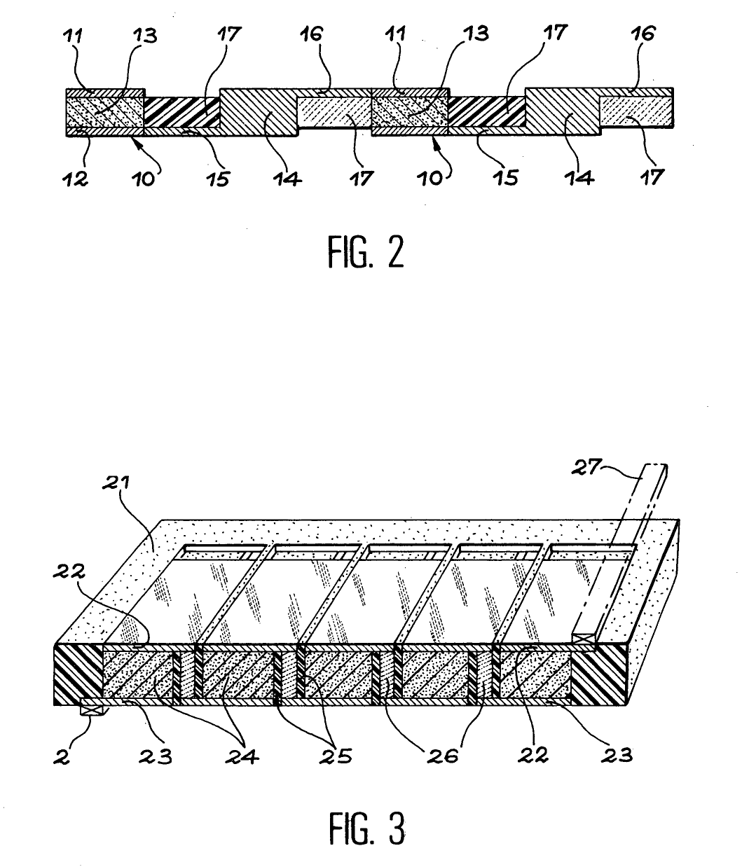

### DESCRIPTION OF A PREFERRED EMBODIMENT OF THE INVENTION

Therefore, FIG. 3 shows the assembly of basic elements according to the invention, once it has been terminated.

All functional elements of this assembly are parts arranged one on the other on and/or in a plate of grid material with a thickness that corresponds to the thickness of the ionic conducting layer.

The assembly comprises firstly a peripheral seal 21 through the entire thickness of the plate around its periphery. This peripheral seal 21 is made using a material that is chemically inert and electronically and ionically isolating.

The different elementary cells in this assembly are each composed of an anode 22 placed on a first surface of the plate, a cathode 23 placed on the opposite surface of the plate and a deposit of an ionic conductor 24 placed between the anode 22 and the cathode 23, through the entire thickness of the plate. Note that the anode projects from one side of the ionic conductor 24 and the cathode 23 projects from the ionic conductor 24 on the side opposite the anode. In this way, each projecting part of the anodes 22 and the cathodes 23 is facing a cathode 23 or an anode 22 of an adjacent cell, except for the thickness of the plate and except for the anode 22 of a first end cell and the cathode 23 of the other end cell.

This special arrangement projecting from the anodes 22 and the cathodes 23 enables an electronic conductor 26 placed through the entire thickness of the plate, to connect the anode 22 in a cell rank n to the cathode 23 in the adjacent cell rank n+1, placed adjacent to it.

Two vertical joint isolating layers 25 separate the electronic conductor 26 from the two parts of the ionic conductor 24 adjacent to it. An electronic conductor 26 is placed on the anode 22 projecting from a first end cell and on the cathode 23 projecting from the other end cell.

Thus, the assembly according to the invention forms a homogenous single block assembly impermeable to gas.

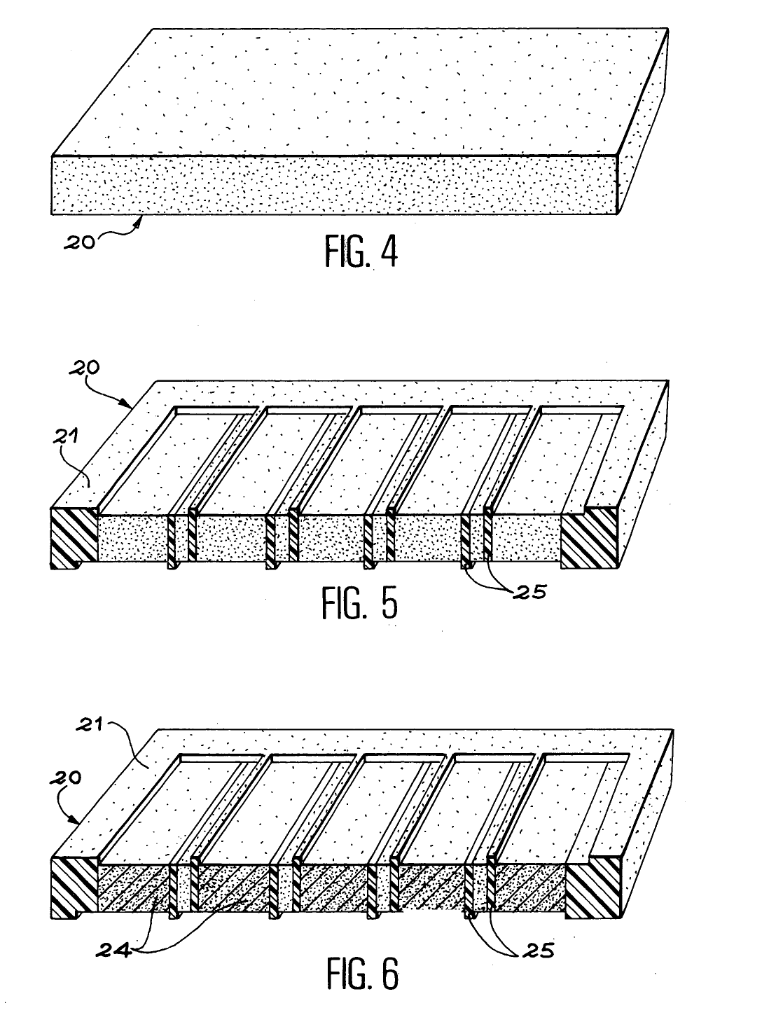

FIG. 4 shows one embodiment of the plate of grid material in the form of porous matrix 20. The shape of this porous matrix 20 is directly related to the fuel cell application for which it is designed and the available space. Therefore different forms are possible, varying from a prismatic cell to a spiral cylinder, and including a single sheet or tube.

The thickness of the porous matrix thus chosen, determines the thickness of the assembly of basic elements made within this porous matrix. A cleaning or chemical treatment may also be necessary depending on the different applications that have to be made of the assembly and the material making up the porous matrix. In this respect, the porous Teflon and porous glass may advantageously be used to make up this porous matrix.

FIG. 5 shows the first phase in the deposition of material on and in the porous matrix 20. The objective is to form the peripheral seal 21 around the periphery of the porous matrix 20, in the form of a deposition of a seal material. The thickness of this peripheral seal 21 is slightly greater than the thickness of the plate 20 so that it can be very slightly compressed. This step is followed by the deposition of several series of two vertical and parallel isolating walls 25 that will delimit and isolate the areas of the plate 20 that will subsequently be filled with the ionic deposit. A small space remains between each pair of vertical isolating walls 25 to enable another later deposit of an electronic conductor. Each isolating wall 25 passes through the entire thickness of the porous matrix 20 and projects from one of the two surfaces of the matrix, such that each isolating wall 25 also separates two anodes or two cathodes.

All these deposits are made using masks placed on the parts of the two surfaces of the porous matrix to which the material to be deposited must not be applied.

FIG. 6 shows a second deposit of material, which is the ionic conductor deposit. Ionic conductor deposits 24 concern areas delimited by pairs of isolating vertical walls 25 and the peripheral seal 21 at this same end. Therefore these deposits of ionic conductors 24 are made throughout the thickness of the porous matrix 20.

FIG. 7 shows the infill of spaces located between two vertical isolating walls 25 in the same pair, using an electronic conducting material 26, and through the entire thickness of the porous matrix 20, in exactly the same way as for deposition of an ionic conductor 24. The material used may be a mix of a seal material and a material containing a conducting fill, such as graphite, carbon or metal.

Still with reference to FIG. 3, the last phase consists of depositing electrodes, in other words anodes 22 and cathodes 23, and joining an electronic conductor 26 to each end of the assembly. The anodes 22 and cathodes 23 must be deposited such that each deposited catalytic layer forming one of these electrodes projects beyond one side of the ionic conducting layer 24 opposite to it that projects beyond the vertical isolating wall 25, to come into intimate contact with the deposit of conducting material 26 located between these two vertical isolating walls 25. The thickness of each layer making up these anodes 22 and cathodes 23 may be no more than a few microns.

A conductor 27 is placed on the anode 22N projecting from a first end of the assembly, while another electrical conductor 27 is placed on the projecting part of the last cathode 23N of the assembly, on the other face of the porous matrix. This porous matrix is thus completely filled and completely covered, except at the peripheral seal 21.

The process according to the invention does not use any machining and is relatively simple, since it only uses material deposition processes, possibly including the use of masks.

It is important to note the nature of the matrix which is porous in this case, but which could be matt or fabric.

Note that the order of the first three deposition steps may be changed.

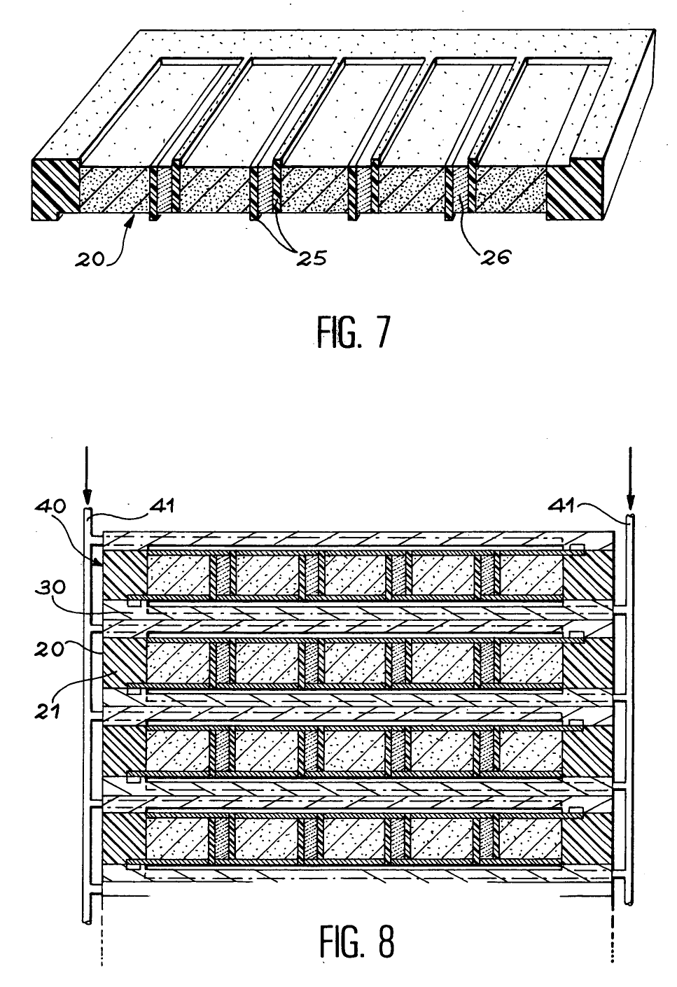

FIG. 8 illustrates an example of a stack made for the construction of a fuel cell in which each stage uses an assembly of basic elements as described above. The complementary constituent elements are two-pole plates 30 each placed between two assemblies mark 40 corresponding to the thickness of the porous matrix 20 plus the compressed overthickness of the peripheral seal 21. A circuit of fuel header pipes 41 is installed on the sides of the stack to supply oxidant and fuel, for example air and hydrogen, to each two-pole plate. For medium and large fuel cells, it will be possible to equip such a stack with an analogue coolant circulation circuit in each two-pole plate. The two-pole plates 30 must then be electronically isolating and must form a gas tight barrier. Frequently used plastic materials such as polysulfone, polyethylene or Teflon, are suitable.

### ADVANTAGES OF THE INVENTION

Any type of plate of grid material can be used. As a result, fuel cells of any section can be built up as a function of the available space set aside for them.

The manufacturing process for this type of basic element does not involve any complicated and expensive machining, and only uses deposition processes. This assembly structure for basic elements may be used for cells operating at high temperature or at low temperature.

The number of basic elements or basic cells forming each assembly may also depend on the voltage to be obtained with fuel cells composed of a series of assemblies.

All applications are possible for this type of fuel cell, but preferred applications are lightweight, portable systems requiring electrical power supplies with voltages of more than one volt and in which weight and shape problems are possible.

The fuel used to supply a cell made in this way, can be stored in the form of a gas compressed outside the cell or in adsorbed form in hydrides, which can be made in the form of hydride sheets in contact with the anodes.

1. Manufacturing process for making an assembly of anode/membrane/cathode basic elements of a stage of a fuel cell and composed of several anode/membrane/cathode basic elements connected to each other through an electronic conductor (26) connecting the anode (22) of one basic element to the cathode (23) of the adjacent basic element, the assembly comprising:
a series of anodes (22) on a first side of a plate forming the assembly, and isolated from each other;
a series of cathodes (23) on the second side of the plate forming the assembly, and isolated from each other and slightly offset from the series of anodes (22);
an ionic conductor (24) between each anode (22)/cathode (23) pair placed within the thickness of the assembly;
the electronic conductor (26);
pairs of vertical isolating walls (25) around each electronic conductor (26);
a peripheral seal (21) placed around all these elements through the entire thickness of the plate, with a slight overthickness on each side,
the process being characterised in that it consists mainly of using a plate of grid material as a support, in which and on which the constituent materials of the different elements of the assembly are deposited, and depositing a joint layer through the entire thickness of the plate around the periphery with a slight overthickness and pairs of two vertical isolating walls (25) to delimit the different basic elements.

2. Manufacturing process according to claim 1, characterised in that the first operation is to cut out a piece of the plate of grid material to the required shape.

3. Manufacturing process according to claim 1 or 2, characterised in that the plate of grid material is a porous matrix (20).

4. Manufacturing process according to claim 3, characterised in that the porous matrix (20) is made of Teflon.

5. Manufacturing process according to claim 3, characterised in that the porous matrix (20) is made of glass.

6. Manufacturing process according to claim 3, characterised in that one operation consists of depositing the ionic conductor (24) through the entire thickness of the plate, but not between the two vertical isolating walls (25) that will delimit the elementary cells.

7. Manufacturing process according to claim 3, characterised in that one operation consists of depositing electronic conductors (26) between the two isolating walls (25).

8. Manufacturing process according to claim 3, characterised in that a subsequent operation consists of depositing anodes (22) on a first surface of the plate thus filled in and cathodes (23) on the other surface of this same plate.

9. Manufacturing process according to claim 8, characterised in that the last phase consists of depositing an electronic conductor (27) placed on one of the two ends of the series of anodes (22) and cathodes (23), opposite each other.
